(19) United States
(12) Patent Application Publication
(10) Pub. No.: US 2002/0068598 A1
(43) Pub. Date: Jun. 6, 2002

(54) Low radiation cellular phone

(76) Inventor: Kevin A. McLean, Tampa, FL (US)

Correspondence Address: Mattew K. Ryan, Esq., c/o FROMMER LAWRENCE & HAUG LLP, 745 FIFTH AVENUE, NEW YORK, NY, 10151, US

(21) Appl. No.: 09/728,204

(22) Filed: Dec. 1, 2000

(51) Int. Cl. H04B 1/38

(52) U.S. Cl. 455/550; 455/90

(57) ABSTRACT

The low radiation cellular phone dramatically lowers the amount of radiation absorbed by the brain by moving the greatest source of radiation further from the brain. The antenna, which is the greatest source of radiation, is located at the bottom of the cellular phone and is therefore the furthest from the brain.

### BACKGROUND OF INVENTION

The field of endeavor to which this invention pertain to is the level of radiation emitted to the brain by cellular phones.

Current cellular phones emit radiation in very small amounts. However, because the source of radiation emissions is very close to the brain, concerns have been raised that the radiation may be causing brain cancer. In fact, the U.S. Federal Communications Commission recently set certain standards for cellular phone radiation absorption. Specifically, the FCC set the standard of 1.6 W/kg for partial-body exposure measured over 1 gram of tissue. This is referred to as the specific absorption rate (SAR) of the phone's radio frequency energy by the brain tissue. The SAR is a way of measuring the quantity of radiofrequency (RF) energy that is absorbed by the body.

The amount of radiation plunges dramatically within inches of the cellular phone and its antenna. Yet, current cellular phones are configured so that that component that emits the most radiation is closest to the brain. Specifically, the antenna emits the greatest amount of radiation and it is the closest component to the brain.

### BRIEF SUMMARY OF THE INVENTION

This invention solves the problems described in the Background of Invention. The invention is a low radiation cellular phone in which the component that emits the greatest amount of radiation is the furthest from the brain. Specifically, the antenna, which is typically located at the top of the cellular phone, is located at the bottom of the cellular phone. This places that component that emits the greatest amount of radiation at the further point from the brain.

### BRIEF DESCRIPTION OF THE DRAWINGS

FIG. 1 is an illustration of the low radiation cellular phone that has the antenna at the bottom.

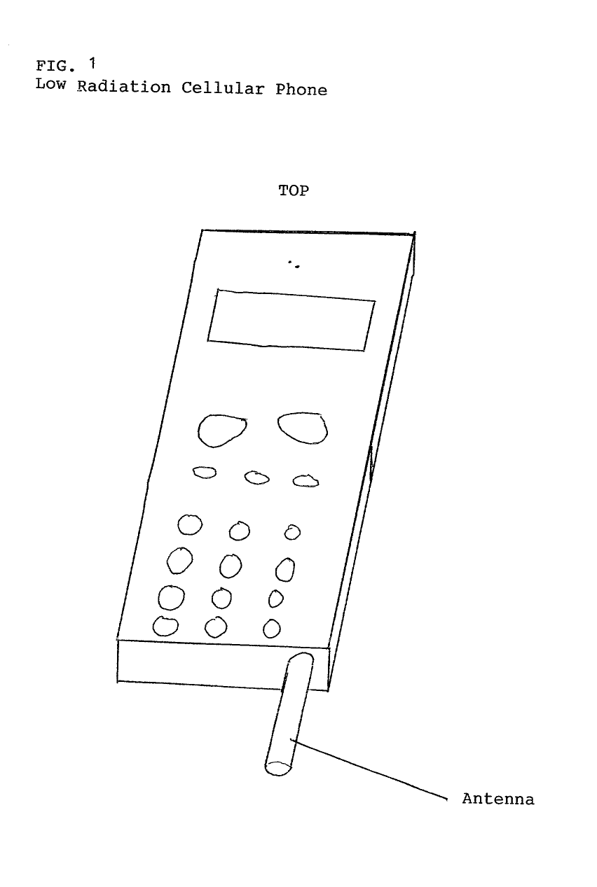

### DETAILED DESCRIPTION OF THE INVENTION

The low radiation cellular phone places the greatest source of radiation the farthest from the brain. The antenna, which emits the greatest amount of radiation, is moved from the top to the bottom. Thus, the greatest source of radiation is moved from the closest point to the brain to the furthest.

Moving the antenna from the closest point to the brain to the furthest point from the brain will dramatically decrease the specific absorption rate (SAR) of the cellular phone, thereby decreasing the risk of cancer and and reducing the user's fear of using the cellular phone.

What is claimed is:

1. A cellular phone apparatus that has its source of greatest radiation furthest from the brain comprising:
a cellular phone having the antenna on the bottom.
